(19) United States
(12) Patent Application Publication
(10) Pub. No.: US 2008/0297447 A1
(43) Pub. Date: Dec. 4, 2008

(54) Display device

(75) Inventors: Kenji Awamoto, Kobe (JP); Manabu Ishimoto, Kobe (JP); Hitoshi Hirakawa, Kobe (JP); Koji Shinohe, Kobe (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CORPORATION, Kobe (JP)

(21) Appl. No.: 12/222,376

(22) Filed: Aug. 7, 2008

Related U.S. Application Data
(63) Continuation of application No. PCT/JP2006/302239, filed on Feb. 9, 2006.

(51) Int. Cl. G09G 3/28

(52) U.S. Cl. 345/60

(57) ABSTRACT

A display device (10) includes: a scan drive circuit (74) operating to apply scan voltages to respective ones of the display electrodes (2, Y1-Yn) during a first period of time, and apply sustain voltage pulses to the ones of the display electrodes (2, Y1-Yn) during a second period of time; a sustain voltage circuit (64) applying a potential for a sustain voltage pulse between two inputs of said scan drive circuit through two respective signal lines (SU, SD) during said second period of time; a switch (SW1) short-circuiting the two input terminals of said scan drive circuit during said second period of time; and a switch control circuit (604) causing said short-circuiting switch to operate. The switch control circuit provides a control signal (SW_CTRL) to operate said short-circuiting switch so as to short-circuit the two input terminals during said second period of time.

This application is a continuation application of international application PCT/JP2006/302239 filed Feb. 9, 2006.

### FIELD OF THE INVENTION

The present invention relates generally to a large-sized display device, and, more particularly, to electrical connections between a scan pulse circuit and a sustain voltage pulse circuit which are connected to display electrodes of a display device including an array of plasma tubes each having a phosphor layer formed therein.

### BACKGROUND OF THE INVENTION

In a plasma display panel (PDP), plasma discharge is generated in closed discharge spaces of a large number of small cells arranged in length and width directions of the panel, and phosphor materials are excited by ultraviolet light of 147 nm emitted from the discharged plasma, to thereby emit light. The cell spaces are formed between two planar glass plates disposed one on the other. On the other hand, in a plasma tube array (PTA), a phosphor layer is formed within a thin, elongated glass tube in which a large number of cell spaces are formed. A large-sized display screen of 6 m×3 m, for example, can be provided by arranging a number of such plasma tubes side by side. In an ordinary plasma tube array, X-electrode sustain voltage pulses are applied to X-electrodes by an X-electrode driver device, and Y-electrode sustain voltage pulses are applied by a Y-electrode sustain voltage pulse circuit in a Y-electrode driver circuit through a scan driver circuit in the Y-electrode driver circuit. The Y-electrode sustain voltage pulse circuit and the scan driver circuit are connected to each other by a flexible cable which is one meter long, for example.

Japanese Patent Application Publication No. 2005-141193-A describes a method of driving a plasma display panel. The driving method includes: coupling in parallel the outputs of a plurality of selection circuits included in one selection circuit group, applying a driving signal to one first electrode, and sequentially applying driving signals to a plurality of the first electrodes. The output of the selection circuit, which is included in the first selection circuit group which outputs the driving signal within the predetermined time before the next driving signal is applied, is caused to be floating. The output of the selection circuit, which is included in the second selection circuit group which outputs the next driving signal, is caused to be floating. The driving currents and power capacity of the selection circuits are thereby increased, and the large-sized PDP is driven by the driver IC of the low capacity used for the small-sized PDP.

### DISCLOSURE OF THE INVENTION

A large-sized plasma tube array having a height of, for example, 2 m, has a number of horizontally extending display electrodes arranged in the vertical direction. It is neither realistic nor efficient to manufacture a printed-circuit board with a single large-scale driver circuit for the display electrodes of the plasma tube array in terms of manufacturing cost and assembly design. Thus, the display electrodes are divided into a plurality of groups, and scan driver circuits for the respective groups of display electrodes are mounted or packaged on respective printed-circuit boards, so that the printed-circuit boards are distributed for the plasma tube array. One printed-circuit board with a sustain voltage pulse circuit is spaced from the plurality of printed-circuit boards with the respective scan driver circuits, and supplies pulse and bias voltages to the respective scan pulse circuit printed-circuit boards through long signal transmission paths. As the plasma tube array is taller, the signal transmission paths become longer.

During a display period for sustain discharge, a sustain pulse voltage is applied by the sustain voltage pulse circuit printed-circuit board to the scan driver circuit printed-circuit boards through the long transmission paths, and the sustain pulse voltage is applied to the display electrodes through diodes in the scan driver circuits. In the long transmission paths, a waveform of the sustain pulse voltage tends to be deformed in shape and delayed in propagation, so that an undesirable instantaneous large difference voltage is applied across the scan driver ICs on the scan driver circuit printed-circuit boards. This may cause unstable operation and/or breakdown of the scan driver ICs. However, use of higher withstanding voltage scan driver ICs causes increase in cost.

The inventors have recognized that, in a large-sized display device of a plasma tube array type, application of undesirable large difference voltage across a scan driver IC on a scan pulse circuit printed-circuit board can be avoided by short-circuiting, on the scan pulse circuit printed-circuit board, signal transmission paths coupled from a printed-circuit board with a sustain voltage pulse circuit to the scan pulse circuit printed-circuit board, during a display period. An object of this invention is to prevent an undesirable large difference voltage from being coupled to a scan pulse circuit via a long signal line.

Another object of the invention is to prevent a scan pulse circuit from failing or being broken down by a long signal line.

### SUMMARY OF THE INVENTION

In accordance with an aspect of the present invention, a display device includes: a plurality of gas discharge tubes arranged side by side, each including a phosphor layer formed therewithin and being filled with discharge gas, each of the gas discharge tubes having a plurality of light emitting points along the length direction thereof; a plurality of display electrodes arranged on a display screen side of the plurality of gas discharge tubes; and a plurality of signal electrodes arranged on a rear side of the plurality of gas discharge tubes. The display device further includes: a scan drive circuit operating to apply scan voltages to respective ones of the display electrodes during a first period of time, and apply sustain voltage pulses to the ones of the display electrodes during a second period of time; a sustain voltage circuit applying a potential for a sustain voltage pulse between two inputs of the scan drive circuit through two respective signal lines during the second period of time; a switch short-circuiting the two input terminals of the scan drive circuit during the second period of time; and a switch control circuit causing the short-circuiting switch to operate. The switch control circuit providing a control signal to operate the short-circuiting switch so as to short-circuit the two input terminals during the second period of time.

In accordance with another aspect of the invention, the display device may include: a plurality of scan drive circuits operating to apply scan voltages to respective ones of the display electrodes during a first period of time, and apply sustain voltage pulses to the ones of the display electrodes during a second period of time; a sustain voltage circuit applying a potential for a sustain voltage pulse between two inputs of each of the plurality of scan drive circuits through two respective signal lines during the second period of time; a plurality of switches, each switch short-circuiting the two input terminals of a corresponding one of the plurality of scan drive circuits during the second period of time; and a switch control circuit causing the plurality of short-circuiting switches to operate. The switch control circuit providing a control signal to operate each of the plurality of short-circuiting switches so as to short-circuit the two input terminals of the corresponding one of the scan drive circuits during the second period of time.

According to the invention, an undesirable large difference voltage can be prevented from being coupled to a scan pulse circuit via a long signal line, and the scan pulse circuit can be prevented from failing or being broken down by a long signal line.

### BRIEF DESCRIPTION OF THE DRAWINGS

FIG. 1 shows an example of a schematic structure of part of an array of plasma tubes or gas discharge tubes of a conventional color display device;

FIG. 2A shows the front support with the plurality of pairs of transparent display electrodes formed thereon, and FIG. 2B shows the rear support with the plurality of signal electrodes formed thereon;

FIG. 3 shows the cross-section of the structure of the array of plasma tubes of the display device in a plane perpendicular to the longitudinal direction;

FIG. 4 shows electrical connections of an X-electrode driver unit, a Y-electrode driver unit and address electrode driver circuits, of the conventional display device;

FIG. 5 shows a schematic driving sequence of output driving voltage waveforms of the X-electrode driver circuit, the Y-electrode driver circuit and the address driver circuit, in the conventional display device;

FIG. 6A shows arrangements of the sustain voltage circuit and the scan pulse circuit for the Y-electrodes in the conventional Y-electrode driver unit;

FIG. 6B shows a waveform of the voltage applied by the conventional sustain voltage pulse circuit, to the input of the conventional scan pulse circuit through the signal lines, FIG. 6C shows a waveform of the voltage applied by the sustain voltage pulse coupling and scan pulse circuit to the Y-electrodes, FIG. 6D is an enlarged view showing waveform variations of the sustain pulse voltage applied to the signal lines, and FIG. 6E shows a difference voltage between the potentials on the two signal lines;

FIG. 7A shows arrangements of a sustain voltage pulse circuit and a scan pulse circuit for the Y-electrodes, according to an embodiment of the present invention;

FIG. 7B shows a waveform of a voltage applied by the sustain voltage pulse circuit through the signal lines to the input of the scan pulse circuit, FIG. 7C shows a waveform of a voltage applied by the sustain voltage pulse coupling and scan pulse circuit, to the Y-electrodes, FIG. 7D shows the ON/OFF states of the switch control signal applied by the control circuit to the scan pulse circuit, FIG. 7E is an enlarged view showing variations of the waveform of the sustain pulse voltage applied to the signal lines, and FIG. 7F shows a voltage difference between the potentials on the two signal lines;

FIG. 8 shows electrical connections of an X-electrode driver unit, a Y-electrode driver unit and address electrode driver circuits, of the display device, in accordance with an embodiment of the present invention;

FIG. 9 shows a scan pulse circuit of the Y-electrode driver unit, in accordance with another embodiment of the invention; and

FIG. 10 shows a scan pulse circuit of the Y-electrode driver unit, in accordance with a further embodiment of the invention.

### DESCRIPTION OF THE PREFERRED EMBODIMENTS

The invention will be described with reference to the accompanying drawings. Throughout the drawings, similar symbols and numerals indicate similar items and functions.

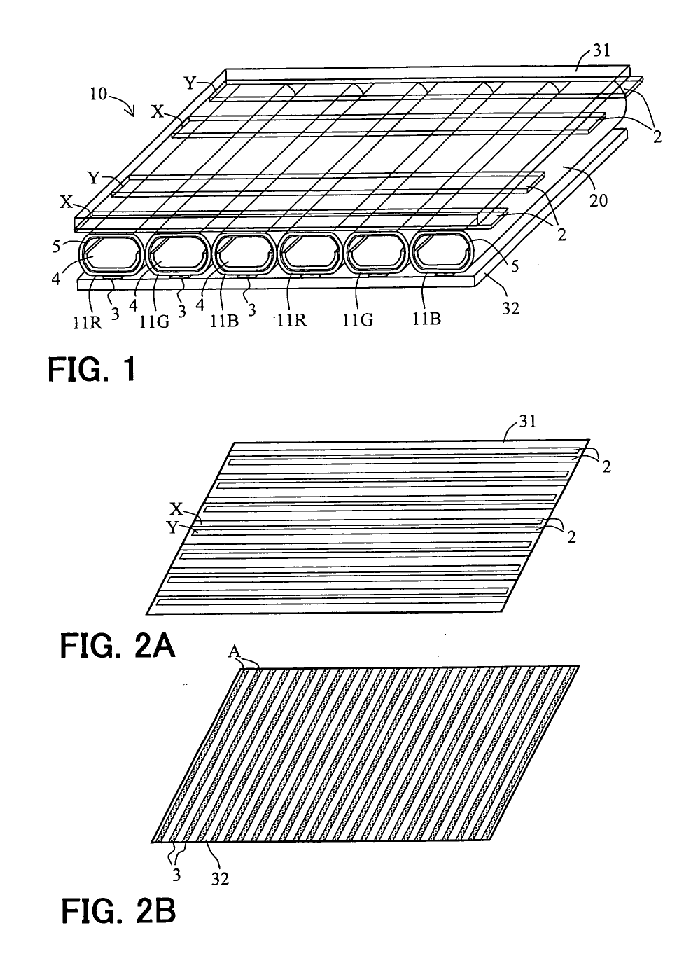

FIG. 1 shows an example of a schematic structure of part of an array of plasma tubes or gas discharge tubes 11R, 11G and 11B of a conventional color display device 10. In FIG. 1, the display device 10 includes an array of thin, elongated transparent color plasma tubes 11R, 11G, 11B, . . . , disposed in parallel with each other, a front support plate 31 composed of a transparent front support sheet or thin plate, a rear support plate 32 composed of a transparent or opaque rear support sheet or thin plate, a plurality of pairs of display or main electrodes 2, and a plurality of signal or address electrodes 3. In FIG. 1, a letter X represents a sustain or X electrode of the display electrodes 2, and a letter Y represents a scan or Y electrode of the display electrodes 2. Letters R, G and B represent red, green and blue, which are colors of light emitted by the phosphors. The front and rear support plates 31 and 32 are made of, for example, flexible or elastic PET or glass films or sheets.

A thin elongated tube 20 for the thin elongated plasma tubes 11R, 11G and 11B is formed of a transparent, insulating material, e.g. borosilicate glass, Pyrex®, soda-lime glass, silica glass, or Zerodur. Typically, the tube 20 has cross-section dimensions of a tube diameter of 2 mm or smaller, for example a 0.55 mm high and 1 mm wide cross section, and a tube length of 300 mm or larger, and a tube wall thickness of about 0.1 mm. Phosphor support members having respective red, green and blue (R, G, B) phosphor layers 4 formed or deposited thereon are inserted into the interior rear spaces of the plasma tubes 11R, 11G and 11B, respectively. Discharge gas is introduced into the interior space of each plasma tube, and the plasma tube is sealed at its opposite ends. An electron emissive film 5 of MgO is formed on the inner surface of the plasma tube 11R, 11G, 11B. The phosphor layers R, G and B typically have a thickness within a range of from about 10 μm to about 30 μm.

Similarly to the gas discharge tubes 11R, 11G and, 11B, the support member is formed of a insulating material, e.g. borosilicate glass, Pyrex®, silica glass, soda-lime glass, or lead glass, and has the phosphor layer 4 formed thereon. The support member can be disposed within the glass tube by applying a paste of phosphor over the support member outside the glass tube and then baking the phosphor paste to form the phosphor layer 4 on the support member, before inserting the support member into the glass tube. As the phosphor paste, a desired one of various phosphor pastes known in this technical field may be employed.

The electron emissive film 5 emits charged particles, when it is bombarded with the discharge gas. When a voltage is applied between the pair of display electrodes 2, the discharge gas contained in the tube is excited. The phosphor layer 4 emits visible light by converting thereinto vacuum ultraviolet radiation generated in the de-excitation process of the excited rare gas atoms.

FIG. 2A shows the front support 31 with the plurality of pairs of transparent display electrodes 2 formed thereon. FIG. 2B shows the rear support 32 with the plurality of signal electrodes 3 formed thereon.

The signal electrodes 3 are formed on the front-side surface, or inner surface, of the rear support plate 32, and extend along the longitudinal direction of the plasma tubes 11R, 11G and 11B. The pitch, between adjacent ones of the signal electrodes 3, is equal to the width of each of the plasma tubes 11R, 11G and 11B, which may be, for example, 1 mm. The pairs of display electrodes 2 are formed on the rear-side surface, or inner surface, of the front support plate 31 in a well-known manner, and are disposed so as to extend perpendicularly to the signal electrodes 3. The width of the display electrode 2 may be, for example, 0.75 mm, and the distance between the edges of the display electrodes 2 in each pair may be, for example, 0.4 mm. A distance providing a non-discharging region, or non-discharging gap, is secured between one display electrode pair 2 and the adjacent display electrode pairs 2, and the distance may be, for example, 1.1 mm.

The signal electrodes 3 and the pairs of display electrodes 2 are brought into intimately contact respectively with the lower and upper peripheral surface portions of the plasma tubes 11R, 11G and 11B, when the display device 10 is assembled. In order to provide better contact, an electrically conductive adhesive may be placed between the display electrodes and the plasma tube surface portions.

In plan view of the display device 10 seen from the front side, the intersections of the signal electrodes 3 and the pairs of display electrodes 2 provide unit light-emitting regions. Display is provided by using either one electrode of each pair of display electrodes 2 as a scan electrode, generating a selection discharge at the intersection of the scan electrode with the signal electrode 3 to thereby select a light-emitting region, and generating a display discharge between the pair of display electrodes 2 using the wall charge formed by the selection discharge on the region of the inner tube surface at the selected region, which, in turn, causes the associated phosphor layer to emit light. The selection discharge is an opposed discharge generated within each plasma tube 11R, 11G, 11B between the vertically opposite scan electrode and signal electrode 3. The display discharge is a surface discharge generated within each plasma tube 11R, 11G and 11B between the two display electrodes of each pair of display electrodes disposed in parallel in a plane.

The pair of display electrodes 2 and the signal electrode 3 can generate discharges in the discharge gas within the tube by applying voltages between them. The electrode structure of the plasma tubes 11R, 11G and 11B shown in FIG. 1 is such that the three electrodes are disposed in one light-emitting region, and that the discharge between the pair of display electrodes generates a discharge for display. However, the electrode structure is not limited to such a structure. A display discharge may be generated between the display electrode 2 and the signal electrode 3. In other words, an electrode structure of a type employing a single display electrode may be employed instead of each pair of display electrodes 2, in which the single display electrode 2 is used as a scan electrode so that a selection discharge and a display discharge (opposed discharge) are generated between the single display electrode 2 and the signal electrode 3.

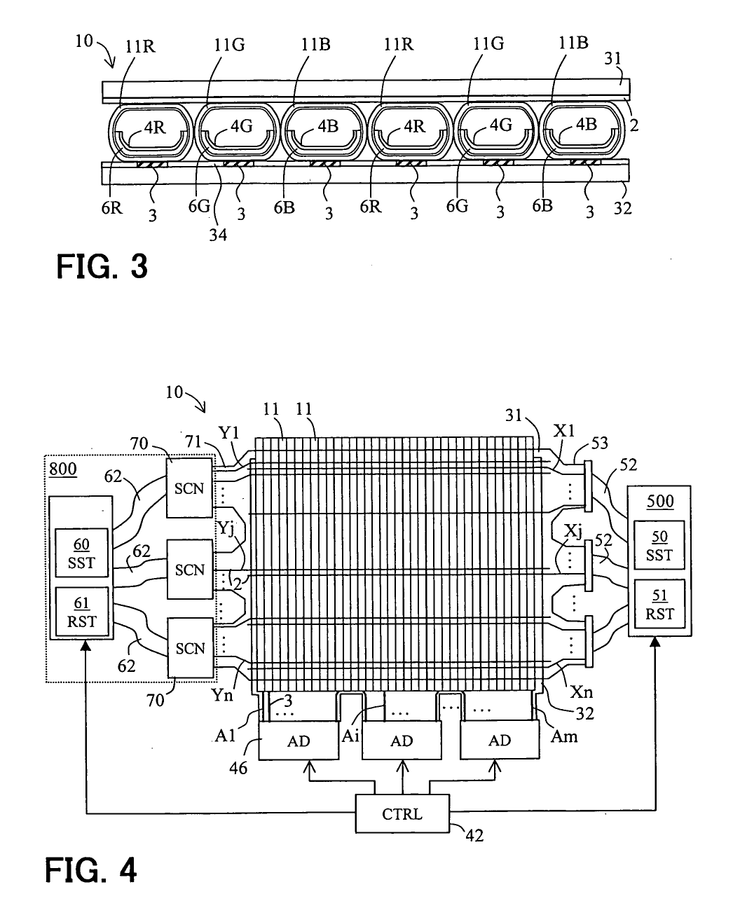

FIG. 3 shows the cross-section of the structure of the array of plasma tubes 11 of the display device 10 in a plane perpendicular to the longitudinal direction. In the display device 10, phosphor layers 4R, 4G and 4B are formed on the inner surface portions of the support members 6R, 6G and 6B in the rear-half spaces of the plasma tubes 11R, 11G and 11B, respectively. The plasma tubes are thin tubes having a tube thickness of 0.1 mm, a width in the cross-section of 1.0 mm, a height in the cross-section of 0.55 mm, and a length of from 1 m to 3 m. For example, the red-emitting phosphor 4R may be formed of an yttria based material ((Y.Ga)BO₃:Eu), the green-emitting phosphor 4G may be formed of a zinc silicate based material (Zn₂SiO₄:Mn), and the blue-emitting phosphor 4B may be formed of a BAM based material (BaMgAl₁₀O₁₇:Eu).

In FIG. 3, the rear support plate 32 is bonded or fixed to bottom surfaces of the red-emitting plasma tubes 11R, 11G and 11B. The signal electrodes 3R, 3G and 3B are disposed on the bottom surfaces of the plasma tubes 11R, 11G and 11B and on an upper surface of the rear support plate 32.

FIG. 4 shows electrical connections of an X-electrode driver unit 500, a Y-electrode driver unit 800 and address electrode driver circuits 46, of the conventional display device 10. In the display device 10, the plasma tube array 11 has n pairs of display electrodes 2, (X1, Y1), . . . , ((Xj, Yj), . . . , (Xn, Yn). Ones of the display electrodes 2 of the pairs of display electrodes 2 are connected from a right end portion 53, divided into plural sections, of the front support plate 31 to a sustain voltage pulse circuit 50 for X-electrodes in the X-electrode driver unit 500 through long flexible cables 52. In addition, the other ones of the display electrodes 2 of the pairs of display electrodes 2 are connected from a left end portion 71, divided into plural sections, of the front support plate 31 to scan pulse circuits 70 in the Y-electrode driver unit 800. A sustain voltage pulse circuit 60 for the Y-electrodes of the Y-electrode driver unit 800 is connected to the scan pulse circuits 70 through long flexible cables 62 having a length of, for example, 1 m. A plurality, m, of signal electrodes 3, A1, . . . , Ai, . . . , Am, are connected to address driver circuits 46 from the lower end divided into plural sections. The X-electrode driver unit 500 includes also a reset circuit 51. The Y-electrode driver unit 800 includes also a reset circuit 61. A driver control circuit 42 is connected to the X-electrode driver circuit 500, the Y-electrode driver circuit 800 and the address driver circuit 46.

The Y-electrode sustain voltage pulse circuit 60 of the Y-electrode driver circuit 800 applies a plurality of potentials for generating sustain voltage pulses and scan pulses for display discharge, to the scan pulse circuits 70 through signal lines of the cables 62, and the applied potentials are selectively applied to the display electrodes Y1-Yn. The X-electrode sustain voltage pulse circuit 50 on the printed circuit board applies a drive voltage or sustain voltage through the flexible cables 52 to the display electrodes X1-Xn formed on the inner surface of the front support plate 31.

Now, one exemplary method for driving an AC gas discharge display device of the plasma tube array type is described. One picture typically has one frame period of approximately 16.7 ms. One frame consists of two fields in the interlaced scanning scheme, and one frame consists of one field in the progressive scanning scheme. For displaying a moving picture in a conventional television system, thirty frames per second must be displayed. In displaying on the display device 10 of this type of AC gas discharge display device, for reproducing colors by the binary control of light emission, one field F is typically divided into or replaced with a set of q subfields SF's. Often, the number of times of discharging for display for each subfield SF is set by weighting these subfields SF's with respective weighting factors of 2⁰, 2¹, 2², . . . , 2^{q-1} in this order. N (=1+2¹+2²+ . . . +2^{q-1}) steps of brightness can be provided for each color of R, G and B in one field by associating light emission or non-emission with each of the subfields in combination. In accordance with such a field structure, a field period Tf, which represents a cycle of transferring field data, is divided into q subfield periods Tsf's, and the subfield periods Tsf's are associated with respective subfields SF's of data. Furthermore, a subfield period Tsf is divided into a reset period TR for initialization, an address period TA for addressing, and a display or sustain period TS for emitting light. Typically, the lengths of the reset period TR and the address period TA are constant independently of the weighting factors for the brightness, while the number of pulses in the display period TS becomes larger as the weighting factor becomes larger, and the length of the display period TS becomes longer as the weighting factor becomes larger. In this case, the length of the subfield period Tsf becomes longer, as the weighting factor of the corresponding subfield SF becomes larger.

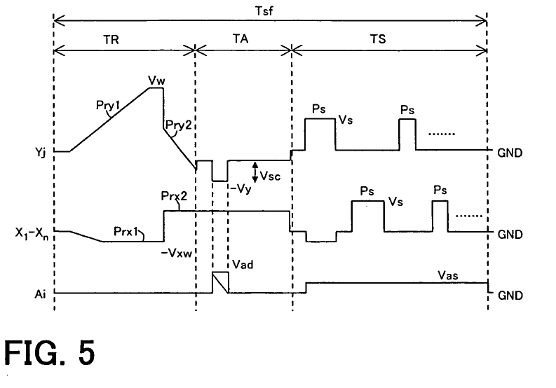

FIG. 5 shows a schematic driving sequence of output driving voltage waveforms of the X-electrode driver circuit 500, the Y-electrode driver circuit 800 and the address driver circuit 42, in the conventional display device 10. The waveform shown is an example, and the amplitudes, polarities and timings of the waveforms may be varied differently.

The q subfields SF's have the same order of the reset period TR, the address period TA and the sustain period TS in the driving sequence, and this sequence is repeated for each subfield SF. During the reset period TR of each subfield SF, a negative polarity pulse Prx1 and a positive polarity pulse Prx2 are applied in this order to all of the display electrodes X's, and a positive polarity pulse Pry1 and a negative polarity pulse Pry2 are applied in this order to all of the display electrodes Y's. The pulses Prx1, Pry1 and Pry2 have ramping waveforms having the amplitudes which gradually increase at the rates of variation that produce micro-discharge. The first pulses Prx1 and Pry1 are applied to produce, in all of the cells, appropriate wall voltages having the same polarity, regardless of whether the cells have been illuminated or unilluminated during the previous subfield. Subsequently, the second pulses Prx2 and Pry2 are applied to the discharge cells on which an appropriate amount of wall charge is present, which adjusts the wall charge to decrease to a level (blanking state) at which sustain pulses cannot cause re-discharging. The driving voltage applied to the cell is a combined voltage which represents difference between the amplitudes of the pulses applied to the respective display electrodes X and Y.

During the address period TA, wall charges required for sustaining illumination are formed only on the cells to be illuminated. While all of the display electrodes X's and of the display electrodes Y's are biased at the respective predetermined potentials, a negative scan pulse voltage −Vy is applied to a row of a display electrode Y corresponding to a selected row for each row selection interval (a scan interval for one row of the cells). Simultaneously with this row selection, an address pulse voltage Va is applied only to address electrodes A's which correspond to the selected cells to produce address discharges. Thus, the potentials of the address electrodes A1 to Am are binary-controlled in accordance with the subfield data Dsf for m columns in the selected row j. This causes address discharges to occur in the discharge tubes of the selected cells between the display electrode Y's and the address electrode A's, and the display data written by the address discharges is stored in the form of wall charges on the cell inner walls of the discharge tubes. A sustain pulse applied subsequently causes surface discharges between the display electrodes X's and Y's.

During the sustain period TS, a first sustain pulse Ps is applied so that a polarity of the first sustain pulse Ps (i.e., the positive polarity in the illustrated example) is added to the wall charge produced by the previous address discharge to cause a sustain discharge. Then, the sustain pulse Ps is applied alternately to the display electrodes X's and the display electrodes Y's. The amplitude of the sustain pulse Ps corresponds to the sustain voltage Vs. The application of the sustain pulse Ps produces surface discharge in the discharge cells which have a predetermined amount of residual wall charge. The number of applied sustain pulses Ps's corresponds to the weighting factor of the subfield SF as described above. In order to prevent undesired opposite discharge between the opposite electrodes during the entire sustain period TS, the addressing electrodes A's are biased at a voltage Vas having the same polarity as the sustain pulse Ps.

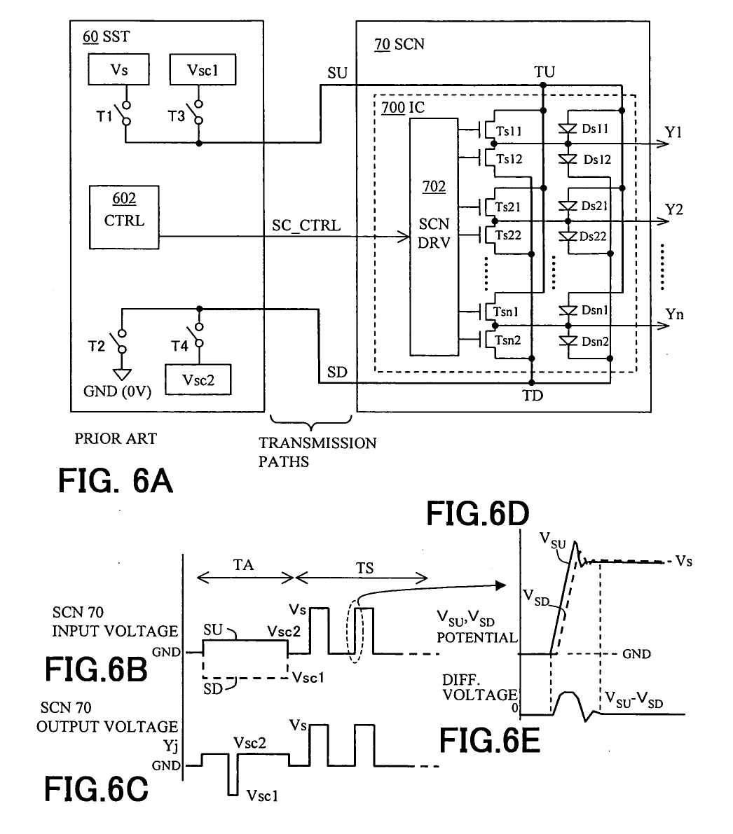

FIG. 6A shows arrangements of the sustain voltage circuit (SST) 60 and the scan pulse circuit (SCN) 70 for the Y-electrodes in the conventional Y-electrode driver unit 800. The sustain voltage pulse circuit (SST) 60 includes a high pulse voltage source Vs connected to a signal line SU through a switch T1, a ground potential GND connected to a signal line SD through a switch T2, a negative bias voltage source Vsc1 connected to the signal line SU through a switch T3, a positive bias voltage source Vsc2 connected to the signal line SD through a switch T4, and a control circuit 602 providing a scan control signal SC_CTRL to the scan pulse circuit 70. The switches T1 and T2 operate during the sustain period TS for coupling the sustain voltage pulses Vs to the Y-electrodes Y1-Yn through the signal lines SU and SD. The switches T3 and T4 operate during the address period TA for coupling the voltage sources Vsc1 and Vsc2 to the scan pulse circuit 70. The scan driver circuit 70 includes a scan driver IC 700. The scan driver IC 700 couples the potential and sustain voltage pulses received through the signal lines SU and SD to the Y-electrodes Y1-Yn, and applies the scan pulse voltage to the Y-electrodes Y1-Yn in accordance with the scan control signal SC_CTRL.

FIG. 6B shows a waveform of the voltage applied by the conventional sustain voltage pulse circuit (SST) 60, to the input of the conventional scan pulse circuit (SCN) 70 through the signal lines SU and SD. FIG. 6C shows a waveform of the voltage applied by the sustain voltage pulse coupling and scan pulse circuit (SCN) 70 to the Y-electrodes Y1-Yn. FIG. 6D is an enlarged view showing waveform variations of the sustain pulse voltage Vs applied to the signal lines SU and SD, and FIG. 6E shows a difference voltage (V_{SU}−V_{SD}) between the potentials V_{SU} and V_{SD} on the two signal lines SU and SD. The sustain pulse voltage Vs is a high voltage of, for example, 250 V, and the maximum value of the difference voltage (V_{SU}−V_{SD}) is, for example, about 50 V near the overshoot.

Referring to FIG. 6B, during the address period TA, the potentials Vsc2 and Vsc1 are applied to two respective input terminals TU and TD of the scan driver IC 700 of the sustain voltage pulse coupling and scan pulse circuit (SCN) 70. Since Vsc1 and Vsc2 are so determined as to be Vsc1<Vsc2, no current flows through diodes Ds11, Ds12, . . . , Dsn1 and Dsn2 of the scan driver IC 700, and the scan pulse Vsc1 is successively applied to the Y-electrodes Y1, Y2, . . . , Yn by ON/OFF controlling switches Ts11, Ts12, . . . , Tsn1 and Tsn2 in the scan driver IC 700.

When the switch T1 of the sustain voltage pulse circuit 60 is turned on during the sustain period TS, current flows from the pulse voltage source Vs of the sustain voltage pulse circuit 60 through the signal line SU and the input terminal TU into diodes Ds11, Ds12, Dsn1 and Ds2, and, then, through the input terminal TD to the signal line SD, so that the potential at the Y-electrodes Y1-Yn rises up to Vs. The time at which the pulse voltage Vs at the input terminal TD rises is somewhat delayed from the time of the rising at the input Terminal TU.

When the switch T2 of the sustain voltage pulse circuit 60 is turned on, the charges stored in the capacitances of the display electrodes (X1, Y1), (X2, Y2), . . . , (Xn, Yn) flow in the form of current from the diodes Ds11, Ds12, . . . , Dsn1 and Dsn2 of the scan driver IC 700 through the signal line SD to the ground potential GND, so that the potentials at the Y-electrodes return to the ground GND. In the described manner, the sustain pulse voltage is applied to the Y-electrodes Y1-Yn. The time at which the pulse voltage Vs at the input terminal TU falls is somewhat delayed from the time of the falling at the input terminal TD.

In the display device 10, since the signal lines or transmission paths SU and SD, which are in the form of the long flexible cables 62, have large inductance, the sustain pulse signal waveform developed at the input terminals of the scan pulse circuit (SCN) 70 contains an overshoot component of a large magnitude of, for example, about 50 V, as shown in FIG. 6D. Then, as shown in FIG. 6E, a large difference voltage of, for example, 50 V occurs instantaneously between the signal lines SU and SD at the input terminals TU and TD of the scan pulse circuit (SCN) 70. This difference voltage tends to cause an undesirable voltage exceeding the withstanding voltage to be instantaneously applied to the switches Ts11, Ts12, . . . , Tsn1 and Tsn2 in the scan driver IC 700. This may cause unstable operation or breakdown of the scan driver IC 700.

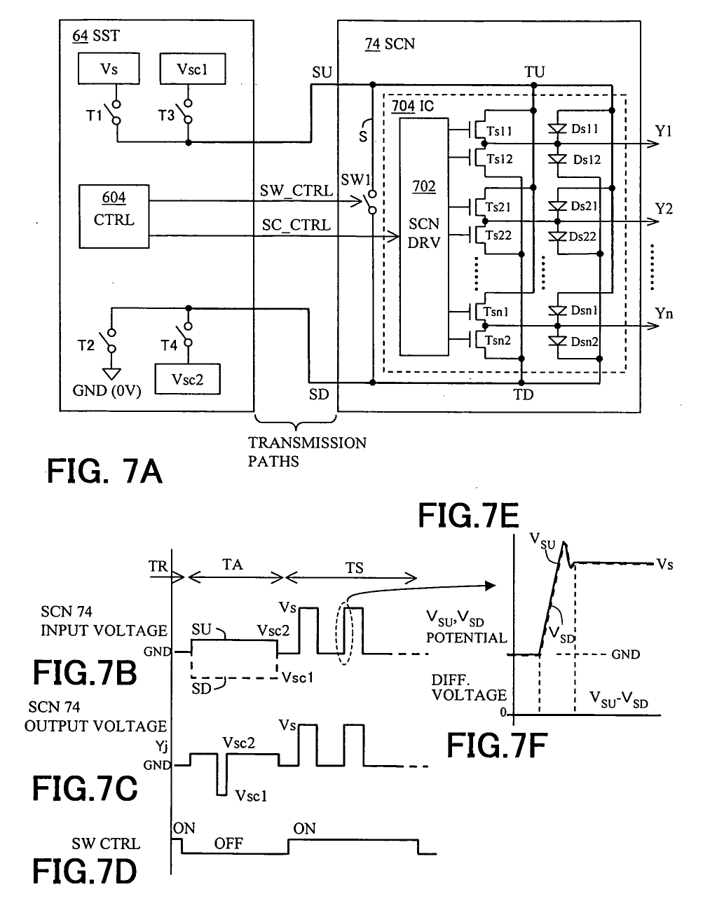

FIG. 7A shows arrangements of a sustain voltage pulse circuit 64 and a scan pulse circuit 74 for the Y-electrodes, according to an embodiment of the present invention. The sustain voltage pulse circuit (SST) 64 includes a high pulse voltage source Vs connected to a signal line SU through a switch T1, a ground potential GND connected to a signal line SD through a switch T2, a negative bias voltage source Vsc1 connected to the signal line SU through a switch T3, a positive bias voltage source Vsc2 connected to the signal line SD through a switch T4, and a control circuit 604 supplying a scan control signal SC_CTRL and a switch control signal SW_CTRL to the scan pulse circuit 74. The scan pulse circuit (SCN) 74 includes a scan driver IC 702, and a switch SW1 for short-circuiting the signal lines SU and SD at locations near input terminals TU and TD by means of a short-circuiting path S. The scan driver IC 702 operates to couple the potential and the sustain voltage pulse received through the signal lines SU and SD to Y-electrodes Y1-Yn, to short-circuit the signal lines SU and SD in response to the switch control signal SW_CTRL, and to couple the scan pulse voltage to the Y-electrodes Y1-Yn in response to the scan control signal SC_CTRL.

FIG. 7B shows a waveform of a voltage applied by the sustain voltage pulse circuit (SST) 64 through the signal lines SU and SD, to the input of the scan pulse circuit (SCN) 74. FIG. 7C shows a waveform of a voltage applied by the sustain voltage pulse coupling and scan pulse circuit (SCN) 74, to the Y-electrodes Y1-Yn. FIG. 7D shows the ON/OFF states of the switch control signal SW_CTRL applied by the control circuit 604 to the scan pulse circuit (SCN) 74. FIG. 7E is an enlarged view showing variations of the waveform of the sustain pulse voltage Vs applied to the signal lines SU and SD, and FIG. 7F shows a voltage difference (V_{SU}−V_{SD}) between the potentials V_{SU} and V_{SD} on the two signal lines SU and SD. The sustain pulse voltage Vs is a high pulse voltage of, for example, 250 V.

Referring to FIG. 7B, it is seen that the operations of the sustain voltage pulse circuit (SST) 64 and the scan pulse circuit (SCN) 74 during an address period (TA) are similar to those shown in FIG. 6A.

During the address period (TA) and a sustain period (TS), the control circuit 604 for the sustain voltage pulse coupling and scan pulse circuit 74 supplies an ON-state representative switch control signal SW_CTRL to the scan pulse circuit (SCN) 74. In response to the switch control signal SW_CTRL, the switch SW1 in the scan pulse circuit (SCN) 74 short-circuits the input terminals TU and TD of the scan driver IC 702 which are connected to the respective signal lines SU and SD. After that, when the switch T1 of the sustain voltage pulse circuit 64 is turned on, current flows from the pulse voltage source Vs in the sustain voltage pulse circuit 64 through the signal line SU and the input terminal TU, and, then, through diodes Ds11, Ds12, . . . , Dsn1 and Dsn2 to the Y-electrodes Y1-Yn, and, at the same time, current flows also through the switch SW1 to the input terminal TD, causing the potentials at the input terminals TU and TD and the Y-electrodes Y1-Yn to rise to thereby cause charge to be stored in the capacitances of the display electrodes (X1, Y1), (X2, Y2), . . . , (Xn, Yn). When the switch T1 is turned off and the switch T2 of the sustain voltage pulse circuit 64 is turned on, the charge stored in the capacitances of the display electrodes (X1, Y1), (X2, Y2), . . . , (Xn, Yn) flows in the form of current through the diodes Ds11, Ds12, . . . , Dsn1 and Dsn2 of the scan driver IC 704, and, then, through the input terminal TD and the signal line SD into the ground potential GND, and, at the same time, current flows through the input terminal TU and the switch SW1 to the signal line SD, to thereby cause the potential at the Y-electrodes Y1-Yn to return to GND. In this manner, the sustain pulse voltage is applied to the Y-electrodes Y1-Yn. Falling in the pulse voltage Vs occurs at the input terminals TU and TD substantially simultaneously.

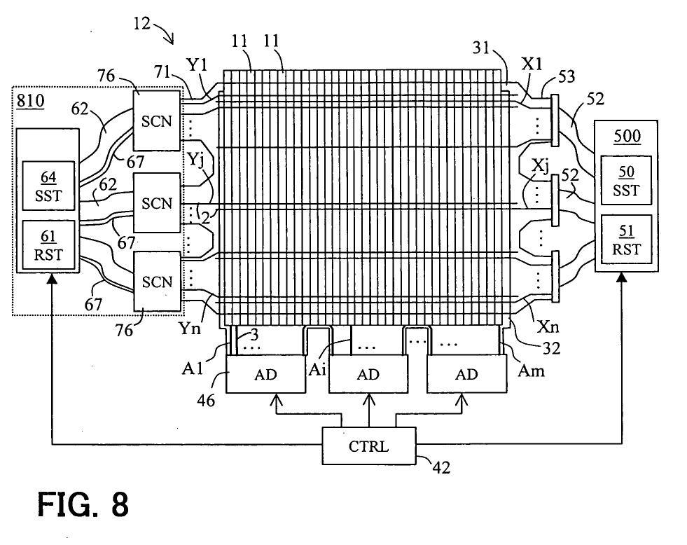

The signal lines or transmission paths SU and SD, which are long flexible cables 62, in the display device 12 (FIG. 8), exhibit a large inductance, and the sustain voltage pulse signal waveforms developed at the input terminals of the signal lines SU and SD of the scan pulse circuit (SCN) 70 contain a large overshoot component of, for example, about 50 V, as shown in FIG. 7E. However, because the signal lines SU and SD at the input terminals TU and TD of the scan pulse circuit (SCN) 70 are biased to the same potential by the switch SW1, the difference voltage is almost zero volts (0 V) at any time, as shown in FIG. 7F. This arrangement avoids the instantaneous application of undesired voltage exceeding the withstanding voltage to the switches Ts11, Ts12, Tsn1 and Tsn2 in the scan driver IC 704. This, in turn, avoids unstable operation and/or breakdown of the scan driver IC 704.

FIG. 8 shows electrical connections of an X-electrode driver unit 500, a Y-electrode driver unit 810 and address electrode driver circuits 46, of the display device 12, in accordance with an embodiment of the present invention. In FIG. 8, a sustain voltage pulse circuit 64 for the Y-electrodes of the Y-electrode driver unit 810 is connected to scan pulse circuits 76 of the Y-electrode driver unit 810 through a plurality of respective long flexible cables 62, which are, for example, more than one (1) m long, and through a plurality of switch control signal lines 67. The remaining configuration of the display device 12 is similar to that of FIG. 4. A control circuit 604 of the sustain voltage pulse circuit 64 for the Y-electrodes provides a switch control signal SW_CTRL to switches SW1 of the respective scan pulse circuits 76 of the Y-electrode driver unit 810 through the respective switch control signal lines 67.

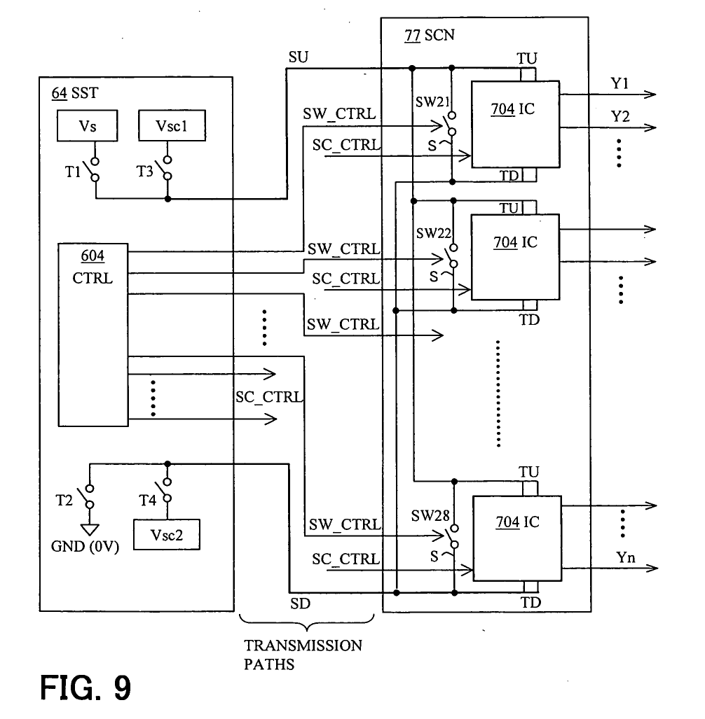

FIG. 9 shows a scan pulse circuit 77 of the Y-electrode driver unit 810, in accordance with another embodiment of the invention. The scan pulse circuit (SCN) 77 includes a plurality of scan driver ICs 704, and switches SW21, SW22, . . . , and SW28, which are all mounted on a single printed-circuit board. The switches SW21, SW22, . . . , and SW28 are provided for short-circuiting, via respective short-circuiting paths S, the signal lines SU and SD at the input terminals TU and TD of the respective scan driver ICs 704. This can avoid instantaneous application of undesired voltage exceeding withstanding voltages to the switches (Ts11, Ts12, . . . , Tsn1 and Tsn2) in each scan driver IC 704.

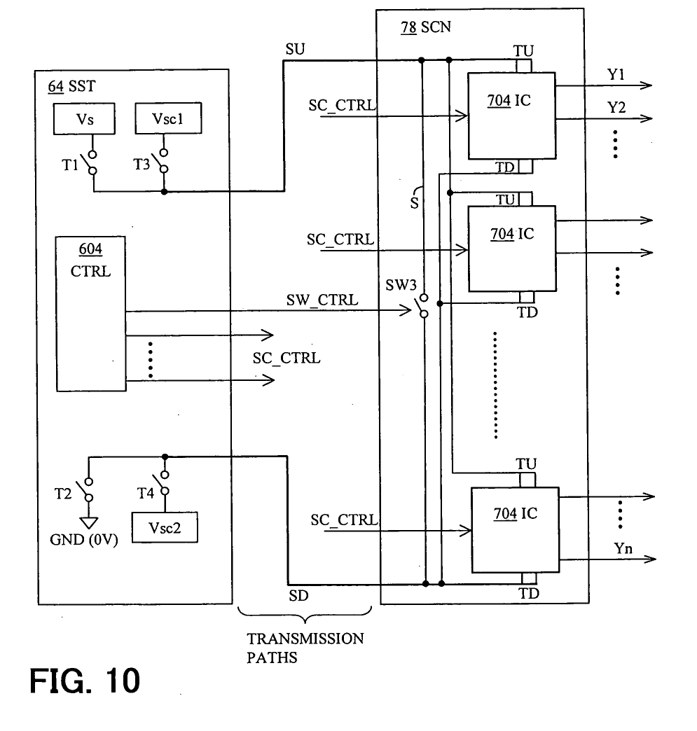

FIG. 10 shows a scan pulse circuit 78 of the Y-electrode driver unit 810, in accordance with a further embodiment of the invention. The scan pulse circuit (SCN) 78 includes one common switch SW3 for short-circuiting the signal lines SU and SD near the input terminal TU of an uppermost one of the plurality of scan driver ICs 704 mounted on a single printed-circuit board and the input terminal TD of a lowermost one of the scan driver ICs 704. This can avoid instantaneous application of undesired voltage exceeding withstanding voltages to switches (Ts11, Ts12, . . . , Tsn1 and Tsn2) in each scan driver IC 704.

The above-described embodiments are only typical examples, and their combination, modifications and variations are apparent to those skilled in the art. It should be noted that those skilled in the art can make various modifications to the above-described embodiments without departing from the principle of the invention and the accompanying claims.

What is claimed is:

1. A display device comprising: a plurality of gas discharge tubes arranged side by side, each including a phosphor layer formed therewithin and being filled with discharge gas, each of said gas discharge tubes having a plurality of light emitting points along the length direction thereof; a plurality of display electrodes arranged on a display screen side of said plurality of gas discharge tubes; and a plurality of signal electrodes arranged on a rear side of said plurality of gas discharge tubes; said display device further comprising:
a scan drive circuit operating to apply scan voltages to respective ones of the display electrodes during a first period of time, and apply sustain voltage pulses to the ones of the display electrodes during a second period of time;
a sustain voltage circuit applying a potential for a sustain voltage pulse between two inputs of said scan drive circuit through two respective signal lines during said second period of time;
a switch short-circuiting the two input terminals of said scan drive circuit during said second period of time; and
a switch control circuit causing said short-circuiting switch to operate;
said switch control circuit providing a control signal to operate said short-circuiting switch so as to short-circuit the two input terminals during said second period of time.

2. The display device according to claim 1, wherein said switch control circuit provides such a control signal as to operate said short-circuiting switch to open a path for short-circuiting between the two input terminals during said second period of time.

3. The display device according to claim 1, wherein said scan drive circuit and said short-circuiting switch are mounted on a same printed-circuit board.

4. A display device comprising: a plurality of gas discharge tubes arranged side by side, each including a phosphor layer formed therewithin and being filled with discharge gas, each of said gas discharge tubes having a plurality of light emitting points along the length direction thereof; a plurality of display electrodes arranged on a display screen side of said plurality of gas discharge tubes; and a plurality of signal electrodes arranged on a rear side of said plurality of gas discharge tubes; said display device further comprising:
a plurality of scan drive circuits operating to apply scan voltages to respective ones of the display electrodes during a first period of time, and apply sustain voltage pulses to the ones of the display electrodes during a second period of time;
a sustain voltage circuit applying a potential for a sustain voltage pulse between two inputs of each of said plurality of scan drive circuits through two respective signal lines during said second period of time;
a plurality of switches, each switch short-circuiting the two input terminals of a corresponding one of said plurality of scan drive circuits during said second period of time; and
a switch control circuit causing said plurality of short-circuiting switches to operate;
said switch control circuit providing a control signal to operate each of said plurality of short-circuiting switches so as to short-circuit the two input terminals of the corresponding one of said scan drive circuits during said second period of time.

5. The display device according to claim 4, wherein said switch control circuit provides such a control signal as to operate each of said plurality of short-circuiting switches to open a path for short-circuiting between the two input terminals of a corresponding one of said scan drive circuits during said second period of time.

6. The display device according to claim 4, wherein said plurality of scan drive circuits and said plurality of short-circuiting switches are mounted on a same printed-circuit board.

7. A display device comprising: a plurality of gas discharge tubes arranged side by side, each including a phosphor layer formed therewithin and being filled with discharge gas, each of said gas discharge tubes having a plurality of light emitting points along the length direction thereof; a plurality of display electrodes arranged on a display screen side of said plurality of gas discharge tubes; and a plurality of signal electrodes arranged on a rear side of said plurality of gas discharge tubes; said display device further comprising:
a plurality of scan drive circuits operating to apply scan voltages to respective ones of the display electrodes during a first period of time, and apply sustain voltage pulses to the ones of said display electrodes during a second period of time;
a sustain voltage circuit applying a potential for a sustain voltage pulse between two inputs of each of said plurality of scan drive circuits through two respective signal lines during said second period of time;
a switch short-circuiting the two signal lines at a location near said plurality of scan drive circuits during said second period of time; and
a switch control circuit operating said short-circuiting switches;
said switch control circuit providing a control signal to operate said short-circuiting switch so as to short-circuit the two signal lines during said second period of time.

8. The display device according to claim 7, wherein said switch control circuit provides such a control signal as to operate said short-circuiting switch to open a path for short-circuiting between the two input terminals during said second period of time.

9. The display device according to claim 7, wherein said plurality of scan drive circuits and said short-circuiting switch are mounted on a same printed-circuit board.
